(19) United States
(12) Patent Application Publication
(10) Pub. No.: US 2018/0027556 A1
(43) Pub. Date: Jan. 25, 2018

(54) METHOD OF TRANSMITTING AND RECEVING SIGNAL TO A PLURALITY OF STATIONS IN WIRELESS COMMUNICATION SYSTEM AND APPARATUS THEREFOR

(71) Applicant: LG ELECTRONICS INC., Seoul (KR)

(72) Inventors: Sungjin PARK, Seoul (KR); Jinmin KIM, Seoul (KR); Hangyu CHO, Seoul (KR); Kyungtae JO, Seoul (KR)

(21) Appl. No.: 15/655,150

(22) Filed: Jul. 20, 2017

Related U.S. Application Data
(60) Provisional application No. 62/364,872, filed on Jul. 21, 2016.

(51) Int. Cl. H04W 72/04; H04W 84/12; H04L 29/06

(52) U.S. Cl. CPC H04W 72/0446; H04L 69/03; H04W 84/12; H04B 7/0617

(57) ABSTRACT

A method of transmitting a signal to a plurality of STAs in a wireless communication system is disclosed in the present specification. The method can include the steps of generating a PPDU for a plurality of the STAs and transmitting the generated PPDU to a plurality of the STAs. In this case, the PPDU is generated based on a first STA among a plurality of the STAs and the first STA may correspond to an STA that the sum of a length of a payload field and a length of a TRN (training) field is longest among a plurality of the STAs.

This application claims the benefit of the U.S. patent application Ser. No. 62/364,872, filed on Jul. 21, 2016, which is hereby incorporated by reference as if fully set forth herein.

### BACKGROUND OF THE INVENTION

### Field of the Invention

The present invention relates to a method of transmitting and receiving a signal in a wireless communication system and an apparatus therefor. In particular, the present invention relates to a method of operating a station (STA) in a wireless LAN (WLAN) system, and more particularly, to a method for a station to transmit a PPDU (physical protocol data unit) to a plurality of STAs in a wireless LAN system.

### Discussion of the Related Art

Standards for the WLAN technology have been developed as Institute of Electrical and Electronics Engineers (IEEE) 802.11 standards. IEEE 802.11a and b use an unlicensed band at 2.4 GHz or 5 GHz. IEEE 802.11b provides a transmission rate of 11 Mbps and IEEE 802.11a provides a transmission rate of 54 Mbps. IEEE 802.11g provides a transmission rate of 54 Mbps by applying Orthogonal Frequency Division Multiplexing (OFDM) at 2.4 GHz. IEEE 802.11n provides a transmission rate of 300 Mbps for four spatial streams by applying Multiple Input Multiple Output (MIMO)-OFDM. IEEE 802.11n supports a channel bandwidth of up to 40 MHz and, in this case, provides a transmission rate of 600 Mbps.

The above-described WLAN standards have evolved into IEEE 802.11ac that uses a bandwidth of up to 160 MHz and supports a transmission rate of up to 1 Gbits/s for 8 spatial streams and IEEE 802.11ax standards are under discussion.

Meanwhile, IEEE 802.11ad defines performance enhancement for high-speed throughput in the 60 GHz band, and IEEE 802.11ay, for introducing channel bonding and MIMO technology to IEEE 802.11ad systems for the first time, is being discussed.

### SUMMARY OF THE INVENTION

Accordingly, the present invention is directed to an apparatus and method thereof that substantially obviate one or more problems due to limitations and disadvantages of the related art.

A technical task of the present invention is to provide a method for an STA to transmit a signal to a plurality of STAs (or multi user (MU)) in a wireless communication system.

Another technical task of the present invention is to provide a method for an STA to determine a length of a PPDU when the STA transmits the PPDU to a plurality of STAs (or multi user).

The other technical task of the present invention is to provide a method for an STA to indicate a length of a payload field of a PPDU and a length of a TRN field in consideration of the PPDU transmitted to a plurality of STAs (multi user).

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In accordance with one embodiment of the present specification, a method of transmitting a signal to a plurality of stations (STAs) in a wireless communication system, the method comprising: generating a PPDU (physical protocol data unit) for a plurality of the STAs; and transmitting the generated PPDU to a plurality of the STAs, wherein the PPDU is generated based on a first STA among a plurality of the STAs, and wherein the first STA corresponds to an STA that the sum of a length of a payload field and a length of a TRN (training) field is longest among a plurality of the STAs.

In accordance with one embodiment of the present specification, a station (STA) transmitting a signal to a plurality of STAs in a wireless communication system, comprising: a transceiving unit having one or more RF (radio frequency) chains and transmitting and receiving a signal; and a processor configured to control the transceiving unit, wherein the processor is further configured to generate a PPDU (physical protocol data unit) for a plurality of the STAs, and transmit the generated PPDU to a plurality of the STAs, wherein the PPDU is generated based on a first STA among a plurality of the STAs, and wherein the first STA corresponds to an STA that the sum of a length of a payload field and a length of a TRN (training) field is longest among a plurality of the STAs.

Also, the followings may commonly be applied to the method and apparatus for transmitting and receiving a signal in a wireless communication system.

In accordance with one embodiment of the present specification, a length of the PPDU is determined by the sum of the length of the payload field and the length of the TRN field.

In accordance with one embodiment of the present specification, payload fields and TRN fields of other STAs except the first STA among a plurality of the STAs are variably determined based on the determined length of the PPDU.

In accordance with one embodiment of the present specification, an end point of a TRN field of each of a plurality of the STAs is determined to be matched in the PPDU.

In accordance with one embodiment of the present specification, a padding bit is added to the payload fields of other STAs except the first STA based on the matched end point of the TRN field in the PPDU.

In accordance with one embodiment of the present specification, the PPDU is generated based on the first STA only when at least one or more STAs performing beamforming training exist among a plurality of the STAs.

In accordance with one embodiment of the present specification, the TRN field of the first STA is indicated by a training length field of an L-header field.

In accordance with one embodiment of the present specification, a length of TRN fields of other STAs except the first STA among a plurality of the STAs is indicated by an EDMG (enhanced directional multi-gigabit) header field.

In accordance with one embodiment of the present specification, a size of an RU (resource unit) allocated to a plurality of the STAs is variably determined.

To achieve these objects and other advantages and in accordance with the purpose of the invention, as embodied and broadly described herein, according to one embodiment,

And, the following items can be commonly applied to a method of eliminating interference in a wireless communication system and an apparatus therefor.

To achieve these objects and other advantages and in accordance with the purpose of the invention, as embodied and broadly described herein, according to one embodiment,

According to the present invention, it is able to provide a method for an STA to transmit a signal to a plurality of STAs (or multi user (MU)) in a wireless communication system.

According to the present invention, it is able to provide a method for an STA to determine a length of a PPDU when the STA transmits the PPDU to a plurality of STAs (or multi user).

According to the present invention, it is able to provide a method for an STA to indicate a length of a payload field of a PPDU and a length of a TRN field in consideration of the PPDU transmitted to a plurality of STAs (multi user).

Effects obtainable from the present invention may be non-limited by the above mentioned effect. And, other unmentioned effects can be clearly understood from the following description by those having ordinary skill in the technical field to which the present invention pertains.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating an exemplary configuration of a Wireless Local Area Network (WLAN) system;

FIG. 2 is a diagram illustrating another exemplary configuration of a WLAN system;

FIG. 3 is a diagram illustrating a channel in a 60 GHz band for explaining a channel bonding operation according to an embodiment of the present invention;

FIG. 4 illustrates a basic method of performing channel bonding in a WLAN system;

FIG. 5 is a diagram illustrating configuration of a beacon interval;

FIG. 6 is a diagram illustrating a physical configuration of an existing radio frame;

FIGS. 7 and 8 are diagrams illustrating configuration of the header field of the radio frame of FIG. 6;

FIG. 9 is a diagram showing a PPDU structure applicable to the present invention;

FIG. 10 is a diagram for a configuration of a TRN field;

FIG. 11 is a diagram for a frame format used for transmitting data in 11ad system;

FIG. 12 is a diagram for a method of transmitting frames corresponding to each of a plurality of streams at the same time;

FIG. 13 is a diagram of a method for an STA to determine a length of a PPDU when the PPDU is transmitted to a plurality of STAs;

FIG. 14 is a diagram of a method for an STA to determine a length of a PPDU when the PPDU is transmitted to a plurality of STAs;

FIG. 15 is a diagram of a method for an STA to determine a PPDU based on an RU (resource unit);

FIG. 16 is a diagram of a method for an STA to transmit a PPDU to a plurality of STAs;

FIG. 17 is a flowchart of a method for an STA to transmit a PPDU to a plurality of STAs;

FIG. 18 is a flowchart for a method of generating and transmitting a PPDU to a plurality of STAs;

FIG. 19 is a diagram illustrating devices for implementing the above-described method.

### DETAILED DESCRIPTION OF THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the present invention.

As described above, a detailed description will be given of the introduction of the concept of a downlink oriented channel, and a method and apparatus for conducting communication using a downlink oriented channel in a high-density Wireless Local Area Network (WLAN) system.

### 1. Wireless LAN (WLAN) System

### 2. Generals of WLAN System

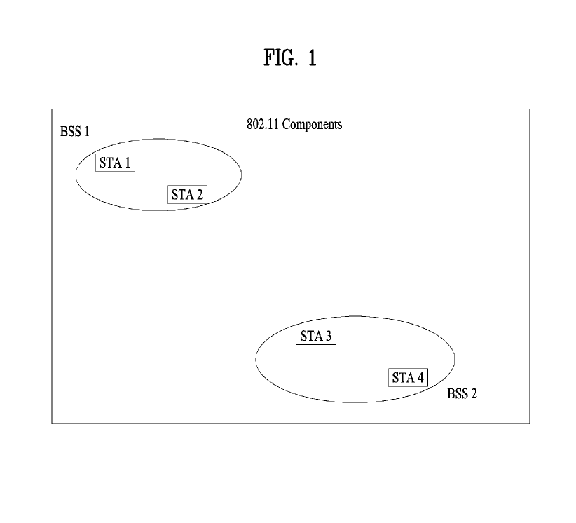

FIG. 1 is a diagram illustrating an exemplary configuration of a WLAN system. As illustrated in FIG. 1, the WLAN system includes at least one Basic Service Set (BSS). The BSS is a set of STAs that are able to communicate with each other by successfully performing synchronization.

An STA is a logical entity including a physical layer interface between a Medium Access Control (MAC) layer and a wireless medium. The STA may include an AP and a non-AP STA. Among STAs, a portable terminal manipulated by a user is the non-AP STA. If a terminal is simply called an STA, the STA refers to the non-AP STA. The non-AP STA may also be referred to as a terminal, a Wireless Transmit/Receive Unit (WTRU), a User Equipment (UE), a Mobile Station (MS), a mobile terminal, or a mobile subscriber unit.

The AP is an entity that provides access to a Distribution System (DS) to an associated STA through a wireless medium. The AP may also be referred to as a centralized controller, a Base Station (BS), a Node-B, a Base Transceiver System (BTS), or a site controller.

The BSS may be divided into an infrastructure BSS and an Independent BSS (IBSS).

The BSS illustrated in FIG. 1 is the IBSS. The IBSS refers to a BSS that does not include an AP. Since the IBSS does not include the AP, the IBSS is not allowed to access to the DS and thus forms a self-contained network.

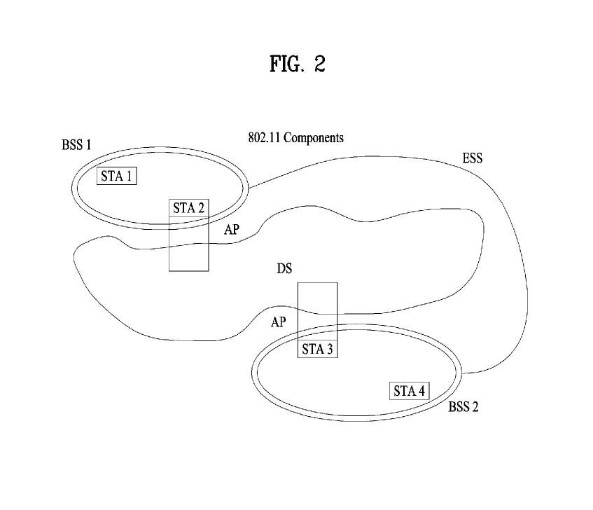

FIG. 2 is a diagram illustrating another exemplary configuration of a WLAN system.

BSSs illustrated in FIG. 2 are infrastructure BSSs. Each infrastructure BSS includes one or more STAs and one or more APs. In the infrastructure BSS, communication between non-AP STAs is basically conducted via an AP. However, if a direct link is established between the non-AP STAs, direct communication between the non-AP STAs may be performed.

As illustrated in FIG. 2, the multiple infrastructure BSSs may be interconnected via a DS. The BSSs interconnected via the DS are called an Extended Service Set (ESS). STAs included in the ESS may communicate with each other and a non-AP STA within the same ESS may move from one BSS to another BSS while seamlessly performing communication.

The DS is a mechanism that connects a plurality of APs to one another. The DS is not necessarily a network. As long as it provides a distribution service, the DS is not limited to any specific form. For example, the DS may be a wireless network such as a mesh network or may be a physical structure that connects APs to one another.

Based on the above, a method of channel bonding in the WLAN system will be described.

### 1-2. Channel Bonding in WLAN System

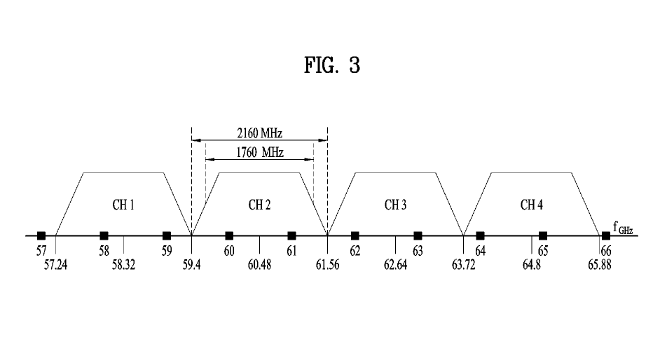

FIG. 3 is a diagram illustrating a channel in a 60 GHz band for explaining a channel bonding operation according to an embodiment of the present invention.

As shown in FIG. 3, four channels may be configured in the 60 GHz band, and the typical channel bandwidth may be 2.16 GHz. The ISM band (57 GHz to 66 GHz) available at 60 GHz may be specified differently for different countries. In general, channel 2 of the channels shown in FIG. 3 is available in all regions and may be used as a default channel. Most of the regions, except Australia, may use channels 2 and 3, which may be utilized for channel bonding. However, the channels used for channel bonding may vary, and the present invention is not limited to a specific channel.

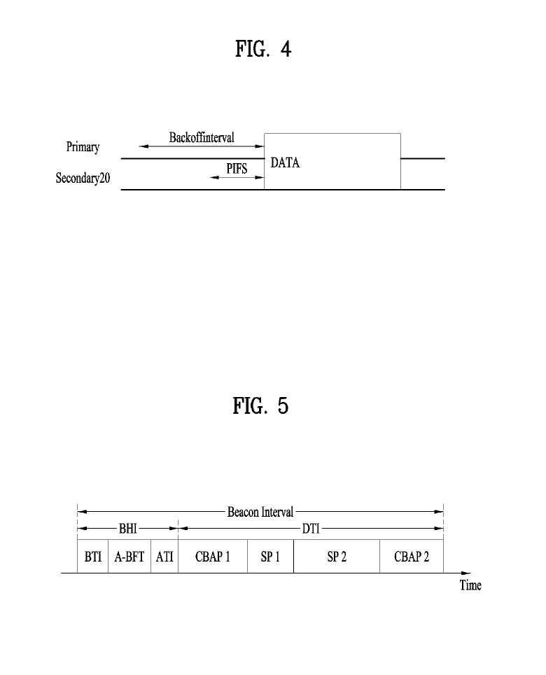

FIG. 4 illustrates a basic method of performing channel bonding in a WLAN system.

The example of FIG. 4 illustrates the operation of 40 MHz channel bonding performed by combining two 20 MHz channels in the IEEE 802.11n system. For IEEE 802.11ac, 40/80/160 MHz channel bonding may be performed.

The two channels exemplarily shown in FIG. 4 include a primary channel and a secondary channel, and the STA may review the channel status of the primary channel of the two channels in the CSMA/CA manner. If the secondary channel is idle for a predetermined time (e.g., PIFS) while the primary channel is idle during a certain backoff interval and the backoff count becomes 0, the STA may transmit data by bonding the primary channel and the secondary channel

In the case where channel bonding is performed based on contention as shown in FIG. 4, channel bonding is allowed only when the secondary channel remains idle for a predetermined time at the time when the backoff count for the primary channel expires, and therefore the application of channel bonding is very limited, and it is difficult to flexibly cope with the media situation.

Accordingly, in one aspect of the present invention, an AP may transmit scheduling information to STAs to perform access based on scheduling. Meanwhile, in another aspect of the present invention, channel access may be performed based on the above-described scheduling or on contention independently of the above-described scheduling. In yet another aspect of the present invention, communication may be performed based on beamforming using a spatial sharing technique.

### 1-3. Beacon Interval Configuration

FIG. 5 is a diagram illustrating configuration of a beacon interval.

In 11ad-based DMG BSS systems, the media time may be divided into beacon intervals. The sub-intervals within a beacon interval may be referred to as access periods. Different access intervals within one beacon interval may have different access rules. The information on the access intervals may be transmitted to a non-AP STA or a non-PCP by the AP or Personal Basic Service Set Control Point (PCP).

As shown in FIG. 5, one beacon interval may include one beacon header interval (BHI) and one data transfer interval (DTI). The BHI may include a beacon transmission interval (BTI), an association beamforming training (A-BFT) interval, and an announcement transmission interval (ATI) as shown in FIG. 4.

The BTI refers to an interval during which one or more DMG beacon frames may be transmitted. The A-BFT interval refers to an interval during which beamforming training is performed by an STA that has transmitted the DMG beacon frame during the preceding BTI. The ATI refers to a request-response-based management access interval between a PCP/AP and a non-PCP/non-AP STA.

Meanwhile, the data transfer interval (DTI) is an interval during which frame exchange is performed between STAs, and may be allocated one or more Contention Based Access Periods (CBAPs) and one or more service periods (SPs) as shown in FIG. 5. Although FIG. 5 illustrates an example of allocation of two CBAPs and two SPs, this is illustrative and not restrictive.

Hereinafter, the physical layer configuration in a WLAN system to which the present invention is applied will be described in detail.

### 1-4. Physical Layer Configuration

It is assumed that the following three different modulation modes may be provided in the WLAN system according to an embodiment of the present invention.

TABLE 1

| PHY | MCS | Note |
|---|---|---|
| Control PHY | 0 | |
| Single | 1 . . . 12 | (low power |
| carrier PHY | 25 . . . 31 | SC PHY) |
| (SC PHY) | | |
| OFDM PHY | 13 . . . 24 | |

Such modulation modes may be used to satisfy different requirements (e.g., high throughput or stability). Depending on the system, only some of these modes may be supported.

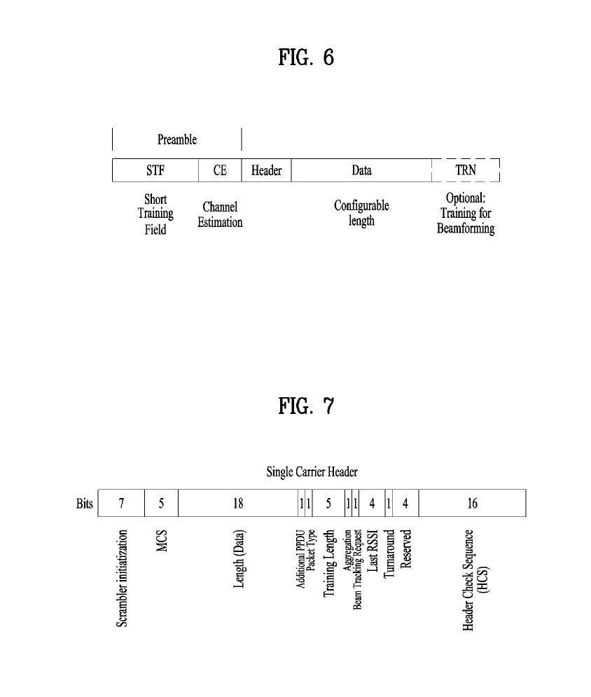

FIG. 6 is a diagram illustrating a physical configuration of an existing radio frame.

It is assumed that all the Directional Multi-Gigabit (DMG) physical layers include fields as shown in FIG. 6 in common. However, depending on the respective modes, physical layers may have a different method of defining individual fields and use a different modulation/coding scheme.

As shown in FIG. 6, the preamble of a radio frame may include a Short Training Field (STF) and Channel Estimation (CE). In addition, the radio frame may include a header and a data field as payload, and selectively include a TRN (Training) field for beamforming.

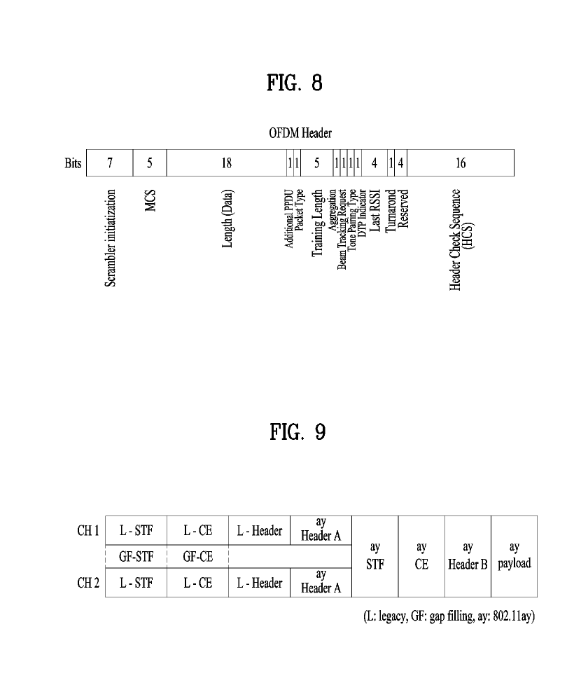

FIGS. 7 and 8 are diagrams illustrating configuration of the header field of the radio frame of FIG. 6.

Specifically, FIG. 7 illustrates a case where a Single Carrier (SC) mode is used. In the SC mode, the header may include information indicating an initial value of scrambling, a Modulation and Coding Scheme (MCS), information indicating the length of data, information indicating the presence or absence of an additional Physical Protocol Data Unit (PPDU), a packet type, a training length, an aggregation status, a beam training request status, a last Received Signal Strength Indicator (RSSI), a truncation status, and a Header Check Sequence (HCS). In addition, as shown in FIG. 7, the header has 4 reserved bits. The reserved bits may be utilized in the following description.

FIG. 8 specifically illustrates configuration of a header in a case where the OFDM mode is applied. The OFDM header may include information indicating an initial value of scrambling, an MCS, information indicating the length of data, information indicating the presence or absence of additional PPDU, a packet type, a training length, an aggregation status, a beam training request status, a last RSSI, a truncation status, and an HCS. In addition, as shown in FIG. 8, the header has 2 reserved bits. The reserved bits may be utilized in the following description as in the case of FIG. 7.

As described above, the IEEE 802.11ay system is considering introduction of channel bonding and MIMO technology in the legacy 11ad system for the first time. In order to implement channel bonding and MIMO in 11ay, a new PPDU structure is needed. In other words, the existing 11ad PPDU structure has limitations in supporting legacy UEs and implementing channel bonding and MIMO.

For this, a legacy preamble for supporting a legacy UE and a new field for a 11ay UE following a legacy header field may be defined, and channel bonding and MIMO may be supported through the newly defined field.

FIG. 9 is a diagram showing a PPDU structure according to a preferred embodiment of the present invention. In FIG. 9, the abscissa may correspond to the time domain, and the ordinate may correspond to the frequency domain.

When two or more channels are bonded, a frequency band (for example, a 400 MHz band) may exist between frequency bands (e.g., 1.83 GHz) used in the respective channels. In the mixed mode, a legacy preamble (legacy STF, legacy CE) is transmitted in duplicate through each channel. In an embodiment of the present invention, transmitting the new STF and CE field (gap filling) preamble through the 400 MHz band between the channels along with transmission of the legacy preamble may be considered.

In this case, as shown in FIG. 9, in the PPDU structure according to the present invention, ay STF, ay CE, ay header B, and payload are transmitted over broadband after a legacy preamble, a legacy header and an ay header A. Therefore, the ay header, ay Payload field, and the like to be transmitted after the header field may be transmitted through channels used for bonding. In order to distinguish the ay header from the legacy header, the ay header may be referred to as an enhanced directional multi-gigabit (EDMG) header, or “ay header” and “EDMG header” may be interchangeably used.

For example, a total of six channels (2.16 GHz) may be present in 11ay, and up to four channels may be bonded and transmitted to a single STA. Thus, the ay header and the ay payload may be transmitted over bandwidths of 2.16 GHz, 4.32 GHz, 6.48 GHz, and 8.64 GHz.

Alternatively, the PPDU format used when the legacy preamble is repeatedly transmitted without performing the gap-filling described above may also be considered.

In this case, the gap-filling is not performed, and thus the ay STF, ay CE, and ay header B are transmitted in a wideband after the legacy preamble, legacy header, and ay header A, without the GF-STF and GF-CE field indicated by the dotted line in FIG. 9.

### 2. TRN Field Configuration

As mentioned in the foregoing description, a TRN field can be configured for beamforming in 11ad system. More specifically, when a PPDU is transmitted, an STA can attach AGC subfields and TRN-R/T subfields to the end of the PPDU for beam refinement and beam tracking. For example, an AGC subfield can be included in consideration of a change of an AWV (antenna weight vector). And, a TRN-T subfield can be used to more delicately perform TX beamforming. A TRN-R subfield can be used to perform not only TX beamforming but also RX beamforming. In this case, beamforming training for both TX and RX can be more delicately performed by attaching both the TRN-T and the TRN-R to a PPDU, by which the present invention may be non-limited. In this case, the TRN field may correspond to a concept including both AGC fields and TRN-R/T subfields.

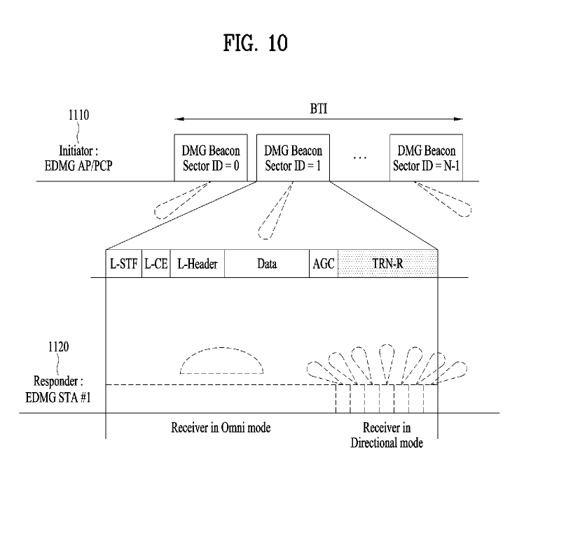

FIG. 10 shows an example of configuring the TRN field. In this case, as an example, an initiator EDMG AP/PCP (Enhanced directional multi-gigabit Access point/personal basic service set (PBSS) control point) 1110 can transmit a beacon frame to a responder EDMG STA 1120 during BTI (beacon transmission interval). In this case, a format of the beacon frame can include an L-STF (Legacy Short Training Field), an L-CE (Legacy Channel Estimation), an L-Header, and a data field in consideration of backward compatibility with a legacy system (i.e., 11ay system). And, it may be able to include an AGC field and a TRN-T/R field as the aforementioned TRN field. In this case, for example, if the TRN-R field is included in the beacon frame, the responder RDMG STA 1120 can perform beamforming training in a directional mode during the TRN-R field. In particular, as mentioned in the foregoing description, the responder EDMG STA 1120 can perform coordination for beamforming in the TRN-R field.

### 3. Method of Controlling PPDU Length Applicable to the Present Invention

As mentioned in the foregoing description, the TRN field can be used for beamforming training. In flay system, since it is able to transmit data using a plurality of channels, when a frame is transmitted using a scheme such as channel boding, channel aggregation, OFDMA, or the like, it is necessary to use a TRN field corresponding to a bandwidth occupied by payload which is decoded by a receiver or a TRN field corresponding to a bandwidth occupied by EDMG STF or EDMG CE. By doing so, it may be able to perform beam refinement and beam tracking optimized for a channel corresponding to a bandwidth currently used by the 11ay system capable of using a plurality of channels. In this case, when a frame is transmitted using a plurality of channels at the same time, a TRN field can be configured in various ways. In this case, a legacy header or an EDMG header may indicate a bandwidth on which a TRN field is transmitted, by which the present invention may be non-limited.

In this case, as mentioned in the foregoing description, since the 11ay system uses a plurality of channels, it is necessary to have more information to perform beamforming training compared to a case of using a single channel. Hence, a length of a TRN field can be extended compared to a TRN field of a legacy 11ad system.

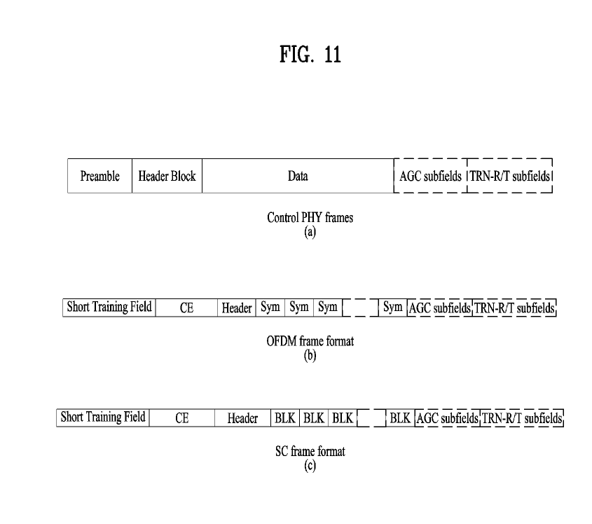

For example, FIGS. 11 (a) to (c) show frame formats used for transmitting data in 11ad system. In this case, as mentioned in the foregoing description, the aforementioned TRN fields can be included in the latter part of a frame to perform beamforming training. In this case, a header field of the frame can indicate information related to the TRN fields.

And, as an example, an STA can transmit a frame to a plurality of STAs at the same time using such a technique as MU-MIMO (multi user-MIMO) and OFDMA. In particular, the STA can use a plurality of channels based on channel bonding and transmit and receive a frame at the same time through bands assigned to a plurality of the STAs. In this case, when a frame is transmitted to a plurality of the STAs at the same time, frame transmission can be performed on two or more channels based on the same method. As a different example, it may be able to transmit a frame to two or more streams based on the same method. In this case, the number of STAs capable of transmitting a frame at the same can be configured by 4 to 6. In particular, the number of STAs can be restricted in consideration of an assigned channel or bandwidth. Yet, this is just an example only. The present invention is not limited by the aforementioned embodiment.

And, for example, an STA can transmit a plurality of streams to a single STA at the same time using SU-MIMO (single user-MIMO). In particular, the STA can transmit frames for multi-stream at the same time.

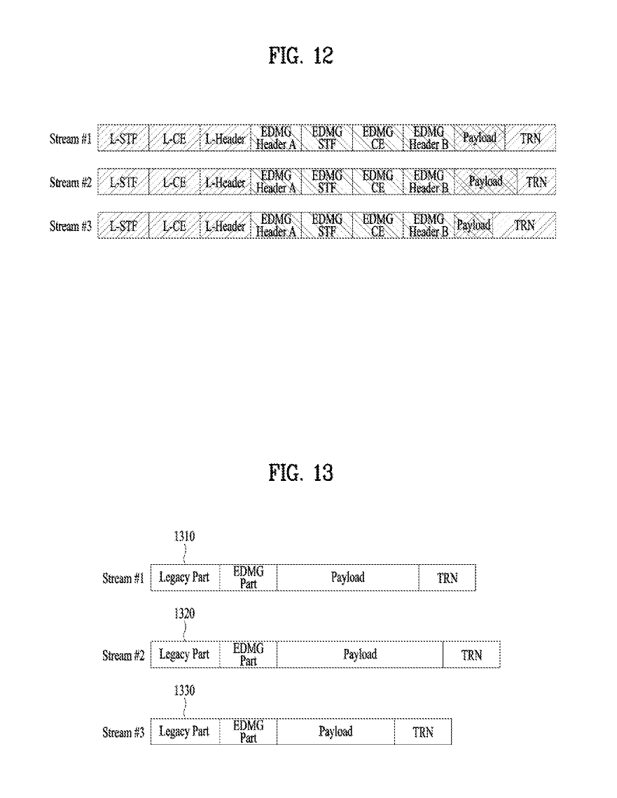

For example, referring to FIG. 12, each frame corresponding to each of a plurality of streams can be transmitted at the same time. In this case, each stream can be transmitted to a different STA. In particular, an STA can transmit a frame to a plurality of STAs at the same time based on MU-MIMO. And, for example, a plurality of streams can be transmitted to a single STA based on SU-MIMO, by which the present invention may be non-limited. In this case, since a frame corresponding to each of a plurality of the streams is transmitted at the same time, it is necessary to identically configure a length of each frame. For example, an STA can identically configure a length of a frame corresponding to each of a plurality of streams in consideration of next transmission or synchronization. In this case, the STA can determine a length of a PPDU for a plurality of STAs based on a length of a payload field (data) and a length of a TRN (training) field of a longest frame among frames corresponding to a plurality of the streams.

More specifically, referring to FIG. 13, it may be able to differently configure a length of a payload field and a length of a TRN field of a frame 1310/1320/1330 corresponding to each stream. In this case, as mentioned in the foregoing description, when an STA transmits each frame to a plurality of STAs, it is necessary to identically configure a frame length in consideration of synchronization and next transmission. In particular, when the STA determines a PPDU for a plurality of STAs, a length of the PPDU can be identically determined.

In this case, for example, one or more STAs among a plurality of the STAs may correspond to an STA requesting a BRP (beam refinement protocol). In particular, there may exist one or more STAs performing beam tracking and beam refinement. In this case, since it is necessary to have a TRN field to perform the beam tracking and the beam refinement, the TRN field can be set to the one or more STAs.

When an STA transmits a frame to a plurality of STAs, the STA can determine a PPDU on the basis of an STA that the sum of a length of a payload field and a length of a TRN field is longest.

Specifically, referring to FIG. 13, each of the streams (stream #1 to stream #3) can be transmitted to each STA. In this case, the sum of a length of the payload field (data field) and a length of the TRN field is longest in an STA that receives a frame 1320 corresponding to a stream #2. In this case, an STA transmitting a PPDU to a plurality of STAs can determine a length of the PPDU on the basis of the sum of the length of the payload field and the length of the TRN field of the frame 1320 corresponding to the stream #2. In particular, the STA transmitting the PPDU to a plurality of STAs can determine the total length of the PPDU on the basis of the frame 1320 corresponding to the stream #2.

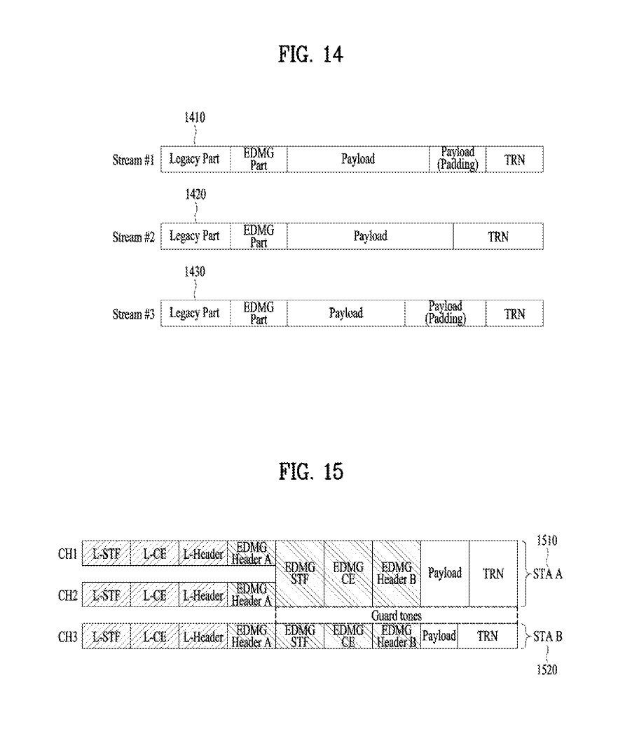

Referring to FIG. 14, in order to adjust a frame length, the last part of a TRN field of a frame 1420 corresponding to a stream #2 can be matched with the last part of a TRN field of a different frame 1410/1430. More specifically, when a length of a PPDU is predetermined, an end point of a TRN field of each frame 1410/1420/1430 can be matched. In this case, as mentioned in the foregoing description, a length of the TRN field can be differently configured according to a frame. If the last part (or end point) of each TRN field is matched, it is necessary to adjust a length of a payload field for each stream. In particular, since a length of a PPDU is determined on the basis of a frame that the sum of the payload field and the TRN field is longest and the last part of the TRN field is matched, a length of a different frame 1410/1430 can be shorter than the predetermined PPDU length. In this case, in order to make the length of each frame 1410/1430 to be identical to the predetermined PPDU length, it may add a padding bit to the payload field. In this case, the padding bit may correspond to a part configured by ‘0’. And, the padding bit does not have any meaning as a data and may correspond to a part for matching a length of a frame. In particular, when an STA transmits a plurality of frames 1410/1420/1430 corresponding to a plurality of streams, the STA adds a padding bit to the payload field on the basis of a frame that the sum of the payload field and the TRN field is longest to adjust a frame length to the predetermined PPDU length.

In this case, for example, the STA transmitting a plurality of the frames 1410/1420/1430 corresponding to a plurality of the streams can variably inform each of the STAs of a length of the payload field and a length of the TRN field within the determined PPDU length. By doing so, each of the STAs can receive a frame based on the determined PPDU length. In this case, each of the STAs can perform an operation based on the length of the payload field and the length of the TRN field indicated by the STA.

As a different example, the STA transmitting a plurality of the frames 1410/1420/1430 corresponding to a plurality of the streams can inform each of the STAs of the determined PPDU length, by which the present invention may be non-limited.

FIG. 15 is a diagram for a method of configuring a PPDU based on a plurality of channels.

Referring to FIG. 15, the number of STAs and a size of an RU (resource unit) can be variably applied. More specifically, for example, an STA A can perform transmission and reception of a signal using a channel 1 and a channel 2. And, for example, an STA B can perform transmission and reception of a signal using a channel 3. In this case, for example, if a plurality of channels are assigned to a single STA, a legacy part (L-STF, L-CE, L-header) and an EDMG header A can be configured according to a channel. And, EDMG-STF, EDMG CE, EDMG header B, payload, and a TRN field can be configured using all bandwidths of a plurality of channels. In the aforementioned situation, when a PPDU is configured for a plurality of STAs, a length of the PPDU can be determined on the basis of a frame that the sum of a payload field and a TRN field is longest, by which the present invention may be non-limited. In particular, a method of determining the PPDU can also be applied to a case that the size of the RU is variable and the number of channels is fixed.

In this case, for example, a training length field positioned at L-header of the legacy part can inform a stream or an STA requiring a longest TRN field length among streams or STAs of the TRN field length. In particular, the training length field of L-header can indicate a TRN field length for a stream or an STA which becomes a reference for determining a length of a PPDU. And, for example, a TRN field length for different streams or STAs can be indicated through EDMG header A and/or EDMG header B. In particular, the training length field of L-header indicates a TRN field length for a stream or an STA corresponding to the longest TRN field length. And, a TRN field length for a different stream or STA can be indicated through EDMG part field.

In this case, in order to indicate whether or not a TRN field is added, it may be necessary to have a 1-bit field according to an STA or a stream as information necessary for indicating the TRN field length. And, if the TRN field is added, a field for indicating the TRN field length is necessary according to an STA or a stream. In this case, the TRN field length can be determined based on the AGC subfield and the TRN-R/T subfield, by which the present invention may be non-limited.

And, a payload field length can be variably configured in consideration of a determined PPDU length and a TRN field length. In particular, the determined PPDU length can be configured in consideration of the length of the TRN field by adding a padding bit to the payload field. And, for example, since EDMG header B includes information on a specific STA only, if the information is included in the EDMG header B, it may be able to reduce overhead, by which the present invention may be non-limited.

In relation to a legacy part, for example, if beamforming training is performed (if BRP is necessary), a packet type field of L-header may correspond to 1. In this case, for example, although the beamforming training is performed on a single STA or stream, the packet type field of L-header may correspond to 1, by which the present invention may be non-limited.

As mentioned in the foregoing description, it may be able to perform beamforming training (beam tracking, beam refinement) according to an STA or a channel corresponding to a bandwidth which is used according to an STA, by which the present invention may be non-limited.

### 4. Method of Operating STA Applicable to the Present Invention

FIG. 16 is a diagram of a method for an STA to transmit a PPDU to a plurality of STAs. Referring to FIG. 16, an STA 1610 can transmit a PPDU to a plurality of STAs. In this case, as mentioned earlier in FIGS. 10 to 15, the STA 1610 can generate a PPDU through a frame which is configured based on each of streams for a plurality of the STAs. In this case, for example, the STA 1610 can generate the PPDU on the basis of an STA that the sum of a length of a payload field and a length of a TRN field is longest among a plurality of the STAs. In particular, a length of the PPDU can be determined on the basis of a frame of the STA that the sum of the length of the payload field and the length of the TRN field is longest among frames for a plurality of the STAs. When the PPDU is generated, an end point of a TRN field of each of a plurality of the STAs can be matched. In this case, since a length of a payload field and a length of a TRN field of each of a plurality of the STAs vary, a length can be matched by adding a padding bit to the payload field for an insufficient length. In this case, as mentioned in the foregoing description, the padding bit is added to match a length and may correspond to a bit to which a practical data is not allocated. Subsequently, the STA 1610 can transmit the PPDU of the determined length to a plurality of the STAs.

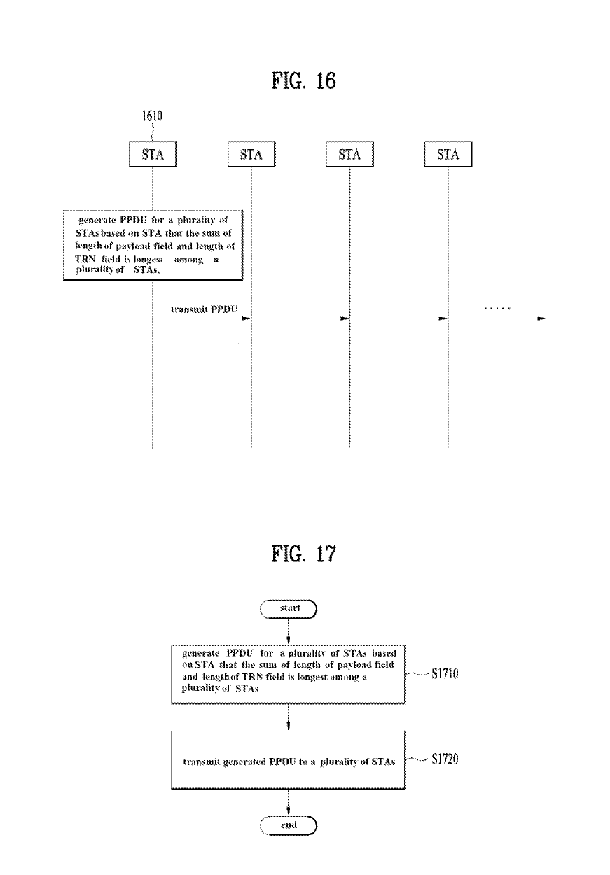

FIG. 17 is a flowchart of a method for an STA to transmit a PPDU to a plurality of STAs.

Referring to FIG. 17, an STA can generate a PPDU for a plurality of STAs based on an STA that the sum of a length of a payload field and a length of a TRN field is longest among a plurality of the STAs [S1710]. In this case, the STA that the sum of the length of the payload field and the length of the TRN field is longest may correspond to a first STA. In this case, for example, information on the first STA can be directly checked through information received from other STAs. And, for example, the STA can check the first STA via signaling, by which the present invention may be non-limited.

And, as mentioned earlier in FIGS. 10 to 16, a length of the PPDU can be determine by the sum of a length of a payload field and a length of a TRN field for the first STA. In this case, since the length of the PPDU is determined by the first STA, a payload field and a TRN field of a different STA can be variably determined. In this case, as mentioned in the foregoing description, it may be able to configure end points of TRN fields of a plurality of the STAs to be matched with each other in the PPDU. In this case, it may be able to add a padding bit to payload fields of other STAs to make a length to be identical to the length of the determined PPDU, by which the present invention may be non-limited. As a different example, the PPDU can be generated based on the first STA only when there is at least one STA performing beamforming training among a plurality of the STAs. In particular, the PPDU can be determined based on the first STA only when one or more STAs requesting BRP exist.

As a further different example, the TRN field of the first STA can be indicated by a training length field of L-header. In particular, a TRN field length of an STA having a longest payload field and a TRN field can be indicated by L-header. For example, as mentioned in the foregoing description, a TRN field length of a different STA can be indicated by EDMG header A or EDMG header B. subsequently, the STA can transmit the generated PPDU to a plurality of the STAs [S1720].

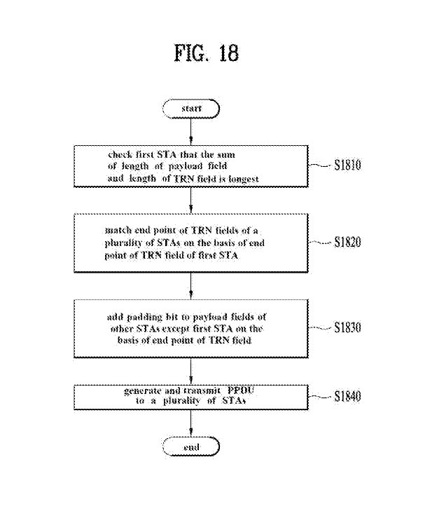

FIG. 18 is a flowchart for a method of generating and transmitting a PPDU to a plurality of STAs.

Referring to FIG. 18, when an STA transmits a PPDU to a plurality of STAs, the STA can check a first STA that the sum of a length of a payload field and a length of a TRN field is longest [S1810]. Subsequently, it may be able to match end points of TRN fields of a plurality of the STAs on the basis of an end point of a TRN field of the first STA [S1820]. In this case, as mentioned earlier in FIGS. 10 to 17, a length of the PPDU can be determined based on the sum of the length of the payload field and the length of the TRN field of the first STA. In this case, since the STA transmits the PPDU to a plurality of the STAs, it is necessary to identically configure the length of the PPDU in consideration of next transmission or synchronization.

Subsequently, the STA can add a padding bit to the payload fields of other STAs except the first STA on the basis of the end point of the TRN field of the first STA [S1830]. Subsequently, the STA can transmit the generated PPDU to a plurality of the STAs [S1840]. In this case, a size of an RU allocated to a plurality of the STAs can be variably determined and the size can also be identically applied to a plurality of channels. As mentioned in the foregoing description, it may be able to perform beamforming training (beam tracking, beam refinement) according to an STA or a channel corresponding to a bandwidth which is used according to an STA, by which the present invention may be non-limited.

### 5. Device Configuration

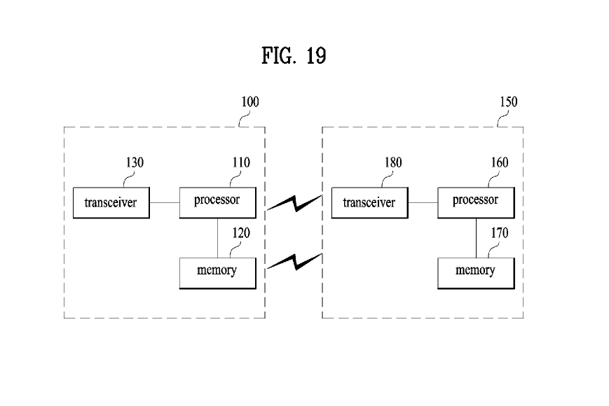

FIG. 19 is a diagram illustrating devices for implementing the above-described method.

In FIG. 19, a wireless device 100 may correspond to an STA that transmits a signal using the above-described EDMG Header-A field and a wireless device 150 may correspond to an STA that receives a signal using the above-described EDMG Header-A field. In this case, each of the STAs may be an 11ay user equipment or PCP/AP. Hereinafter, for convenience of description, the signal transmitting STA is referred to as a transmitting device 100 and the signal receiving STA is referred to as a receiving device 150.

The transmission device 100 may include a processor 110, a memory 120 and a transceiver 130. The reception device 150 may include a processor 160, a memory 170, and a transceiver 180. The transceivers 130 and 180 may transmit/receive wireless signals and may be implemented in a physical layer such as IEEE 802.11/3GPP. The processors 110 and 160 are implemented in the physical layer and/or MAC layer and are connected to the transceivers 130 and 180. The processors 110 and 160 may perform the UL MU scheduling procedure described above.

The processors 110 and 160 and/or the transceivers 130 and 180 may include application specific integrated circuits (ASICs), other chipsets, logic circuits, and/or data processors. The memories 120 and 170 may include a read-only memory (ROM), a random access memory (RAM), a flash memory, a memory card, a storage medium and/or other storage units. When an embodiment is executed by software, the method described above may be executed as a module (e.g., a process, a function) that performs the functions described above. The module may be stored in the memory 120,170 and executed by the processor 110,160. The memory 120, 170 may be located inside or outside the processor 110, 160 and may be connected to the processor 110, 160 by a well-known means.

The detailed description of preferred embodiments of the invention set forth above is provided to enable those skilled in the art to implement and practice the invention. Although the present invention has been fully described by way of example with reference to the accompanying drawings, it is to be understood that various modifications and changes may be made in the invention without departing from the scope and spirit of the invention. Accordingly, the present invention is not intended to be limited to the embodiments disclosed herein but is to be accorded the widest scope consistent with the principles and novel features disclosed herein.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of transmitting a signal to a plurality of stations (STAs) in a wireless communication system, the method comprising:
generating a PPDU (physical protocol data unit) for a plurality of the STAs; and
transmitting the generated PPDU to a plurality of the STAs,
wherein the PPDU is generated based on a first STA among a plurality of the STAs, and
wherein the first STA corresponds to an STA that the sum of a length of a payload field and a length of a TRN (training) field is longest among a plurality of the STAs.

2. The method of claim 1, wherein a length of the PPDU is determined by the sum of the length of the payload field and the length of the TRN field.

3. The method of claim 2, wherein payload fields and TRN fields of other STAs except the first STA among a plurality of the STAs are variably determined based on the determined length of the PPDU.

4. The method of claim 3, wherein an end point of a TRN field of each of a plurality of the STAs is determined to be matched in the PPDU.

5. The method of claim 4, wherein a padding bit is added to the payload fields of other STAs except the first STA based on the matched end point of the TRN field in the PPDU.

6. The method of claim 1, wherein the PPDU is generated based on the first STA only when at least one or more STAs performing beamforming training exist among a plurality of the STAs.

7. The method of claim 1, wherein the TRN field of the first STA is indicated by a training length field of an L-header field.

8. The method of claim 7, wherein a length of TRN fields of other STAs except the first STA among a plurality of the STAs is indicated by an EDMG (enhanced directional multi-gigabit) header field.

9. The method of claim 1, wherein a size of an RU (resource unit) allocated to a plurality of the STAs is variably determined.

10. A station (STA) transmitting a signal to a plurality of STAs in a wireless communication system, comprising:
a transceiving unit having one or more RF (radio frequency) chains and transmitting and receiving a signal; and
a processor configured to control the transceiving unit,
wherein the processor is further configured to
generate a PPDU (physical protocol data unit) for a plurality of the STAs, and
transmit the generated PPDU to a plurality of the STAs,
wherein the PPDU is generated based on a first STA among a plurality of the STAs, and
wherein the first STA corresponds to an STA that the sum of a length of a payload field and a length of a TRN (training) field is longest among a plurality of the STAs.

11. The STA of claim 10, wherein a length of the PPDU is determined by the sum of the length of the payload field and the length of the TRN field.

12. The STA of claim 11, wherein payload fields and TRN fields of other STAs except the first STA among a plurality of the STAs are variably determined based on the determined length of the PPDU

13. The STA of claim 12, wherein an end point of a TRN field of each of a plurality of the STAs is determined to be matched in the PPDU.

14. The STA of claim 13, wherein a padding bit is added to the payload fields of other STAs except the first STA based on the matched end point of the TRN field in the PPDU.

15. The STA of claim 10, wherein the PPDU is generated based on the first STA only when at least one or more STAs performing beamforming training exist among a plurality of the STAs.
